(19) United States
(12) Patent Application Publication
(10) Pub. No.: US 2016/0337833 A1
(43) Pub. Date: Nov. 17, 2016

(54) SYSTEM AND METHOD FOR LEAST COST CALL ROUTING AMONG MULTIPLE SERVICE PROVIDERS

(71) Applicant: ORANGE, Paris (FR)

(72) Inventors: John Benko, San Francisco, CA (US); Akshay Jain, Foster City, CA (US); Dachuan Yu, Redwood City, CA (US); Ombeline Choupin, Burlingame, CA (US)

(73) Assignee: ORANGE, Paris (FR)

(21) Appl. No.: 15/112,381

(22) PCT Filed: Jan. 16, 2015
(86) PCT No.: PCT/IB2015/000155

§ 371 Date: Jul. 18, 2016

Related U.S. Application Data
(60) Provisional application No. 61/928,217, filed on Jan. 16, 2014.

(51) Int. Cl. H04W 4/24; H04M 15/10; H04M 15/00

(52) U.S. Cl. CPC H04W 4/24; H04M 15/8044; H04M 15/56; H04M 15/09; H04M 15/10; H04M 15/49

(57) ABSTRACT

A system and method for call routing among multiple service providers is disclosed. In one aspect, a call dialed by the user is directed to a call routing broker for determination of a cost effective or otherwise best call option for the user. If an option to place a call through a service provider that does not incur extra charge and does not accrue data or minutes against a plan quota, the call will be placed through that service provider. If only an option to place the call through a service provider that does not incur extra charge but does accrue data and/or minutes is identified, the call will be placed through that service provider. If only an option to place the call through a service provider that does incur extra charge, the call will be placed through a service provider selected based in part on the best rates.

### BACKGROUND

1. Technological Field

The present application relates generally to routing calls, and more specifically to a system and method for routing calls among multiple service providers through a broker application running on a portable wireless device.

2. Description of Related Technology

Recent development of widely available network connection has promoted various wireless devices utilizing network connection to perform functions such as placing a voice call. In turn, users have abundant calling options including not only through network carriers under their calling plans but also over-the-top (OTT) voice-over-IP (VoIP) services and pre-paid or toll-free communication services.

Departing from traditional wireless carrier plans, OTT VoIP services and pre-paid services provide rates and billing schemes that can be more cost effective to individual users depending on the type of calls the user makes, for example.

While users have various calling options with respective costs, users often are required to set up multiple accounts and use multiple software applications. In addition, they need to compare various billing rates and schemes and keep up-to-date information regarding rates and availability if there are to fully take advantage of the numerous calling options.

Accordingly, a system and method for routing calls among multiple communication service providers is desirable.

### SUMMARY OF CERTAIN INNOVATIVE ASPECTS

In one innovative aspect, there is a method for routing a call from a caller to a recipient with a broker application. The method includes identifying a plurality of available communication services to call the destination number. The method also includes obtaining cost factor information for the plurality of available communication services using an application interface of at least one communication service provider. The method also includes determining cost of calling the destination number through each of the plurality of communication services based on the cost factor information. The method further includes selecting a communication service form the plurality of communication services based at least in part on the determined cost. The method further includes placing the call to the destination number through the selected communication service.

In another innovative aspect, there is a system for routing a call from a caller to a recipient with a broker application. The system includes a processor executing software. The software is configured to receive a destination number for the call. The software is also configured to identify a plurality of available communication services to call the destination number. The software is also configured to obtain cost factor information for the plurality of available communication services using an application interface of at least one communication service provider. The software is further configured to determine cost of calling the destination number through each of the plurality of communication services based on the cost factor information. The software is also configured to select a communication service from the plurality of communication services based at least in part on the determined cost. The software is further configured to place the call to the destination number through the selected communication service.

The system and method of the invention each has several aspects, no single one of which is solely responsible for its desirable attributes. Without limiting the scope of this invention as expressed by the claims which follow, some features will now be discussed briefly. After considering this discussion, and particularly after reading the section entitled “Detailed Description” one will understand how the features of this invention provide advantages that include data plan and usage based application interface control.

### BRIEF DESCRIPTION OF THE DRAWINGS

FIG. 1 is a functional block diagram of an exemplary communications system employing a voice and data network.

FIG. 2 is a functional block diagram of an exemplary portable wireless communications device.

FIG. 3 is a flowchart for an exemplary method of call routing.

FIG. 4 is an illustration of an exemplary call summary screen shot of a call broker application.

### DETAILED DESCRIPTION OF CERTAIN ILLUSTRATIVE EMBODIMENTS

In one embodiment, a wireless communications system comprises servers and a broker application residing in a portable wireless communications device configured to route calls dialed by a user. The servers include a broker server and one or more OTT service provider server, from which cost information regarding a call can be obtained. The routing process, for example, is based on the user's carrier plan information, data plan information and available OTT service information to select the optimal call option for the call number dialed by the user and place the call. An embodiment of the routing process includes settings by the end user and/or the broker service provider to incorporate pre-determined priorities or preferences of the end user and/or the broker service provider. The call routing can be based on various factors including but not limited to cost, quality of service (QoS) and network connectivity Implementations of routing a call based on cost are described in detail below, but the routing paradigm is extensible to include other factors.

The exemplary caller, or user, has multiple available options to make a call. The user will generally subscribe to a monthly voice plan through a network carrier, which, for instance, offers a fixed number of minutes per month for a flat charge and any excess minutes are charged by the minute. The voice plan may also provide unlimited free minutes for calls between the same network carrier as long as the calls are made between, say, 10 PM and 5 AM so that the user can make calls to anyone using the same network carrier for free during the predetermined time of the day. The voice plan for 500 minutes in this example may only include domestic calls, and the user can only make international calls at extra cost if the user places international calls through the network provider. In addition to the voice plan, a user in this example can also subscribe to a data plan through the network carrier, which offers, say, 5 GB of data per month for a flat charge and any data usage in excess paid per byte.

Through these voice and data plans, the user in this example would have various options to place a call ranging from making a regular voice call through the carrier network to making a VoIP call through an OTT application using Internet connectivity.

For example, the user may have many voice plan minutes available for the current month. If the user makes a regular call through the carrier network, there will be no additional charge. At another time, however, the user may have used all 500 minutes in the current month and would incur an extra charge if a call is made through the carrier network. However, if a call is made at, say, 11 PM to a person who is also on the same carrier network, there will be no extra charge for the call since it is a free unlimited same-carrier night call provided by the voice plan. On the other hand, if the callee resides in a different country, an extra charge will be applied, since the voice plan does not include international calls.

Instead of using the regular carrier network as described above, the user may want to use VoIP call services. Here, the user will encounter a different set of factors that determine the cost of a call. If, for example, the monthly data quota of 5 GB has not been exceeded, the VoIP service can be used without incurring any extra data charges. However, the user may have to pay rates specific to the VoIP service provider. At another time, the monthly data limit has been exceeded, and making a VoIP call using more data will incur an extra charge. However, if free Wi-Fi access is available, making a VoIP call will not incur extra data charges. Here again, the caller may have to pay specific charges for the VoIP call service, but if the callee happens to be online with the same VoIP service, the call will be free of charge under the VoIP plan and there will be no charge by the carrier.

Another option in this example to is make a call through pre-paid call services. Here, there is a different set of factors that determine the cost of a call. For example, the caller may have some pre-paid minutes left in a pre-paid call service provider account. In this case, the pre-paid minutes can be used at no additional charge. On the other hand, all the pre-paid minutes may have been expended. Either the same or another pre-paid call service will be selected to pay for minutes before making the call.

With mobile device application as disclosed below, various service charges for particular circumstances, the call number, the callee location and available services, a comparison is made to determine which calling option is most cost efficient. For example, a call can be placed using a native dialer on a smartphone in a way indistinguishable from placing a call through the carrier network. Instead of allowing the call to be placed through the carrier network by default, the dialed call number will be directed to a broker application and the broker application proceeds to determine the most cost efficient option.

In one implementation, the broker application receives the dialed number and determines whether there is an option to make the call free of extra charge without accruing minutes or data against an available quota. The broker application can determine whether the user has any OTT VoIP application installed in the caller's device and whether the callee is available through the same VoIP service. If the broker determines that both the caller and the callee are available on the same VoIP service, the broker application places a call through the OTT application so long as the caller's Internet connection, e.g., Wi-Fi, that is available. At another time, the broker application can determine whether the caller and the callee are in the same domestic carrier network and the caller has same-carrier free minutes available all the time or depending the time of the day, for instance. The broker application then places the call through the regular network carrier since the call does not incur an extra charge and does not impact the plan quota.

If the broker application determines that the above-noted option to make is unavailable, it determines whether there is an option to make the call without extra charge while accruing minutes or data against the available plan quota. The broker application can determine that monthly domestic minutes are available under the voice plan. In this case, the call is placed via the carrier and minutes accrue against the quota so long as the call is domestic. Alternatively, the caller may have data quota available in a data plan. The broker places a call through a VoIP service without extra charge yet accruing data against the quota as long as the VoIP service does not cause separate charges. In yet another scenario, the user may have an account with a pre-paid call service provider and have pre-paid minutes available. The broker application then places a call using the pre-paid account at no extra charge while accruing minutes against the pre-paid available minutes.

If the broker application determines that there is no option to place the call without incurring extra charge, it determines which option would provide the most cost efficient service. The broker application can obtain rate information from various communications service providers and compare the rates given the dialed number, time of day, etc.

In another scenario, the broker application may determine that placing the call may not initially incur any extra charge, but will eventually cost the user extra fees if the call continues for more than a certain duration. Then, the broker application, for example, may select a call option based on factors other than simple calling rates. For instance, the broker application may obtain information about the caller's calling habit with regard to a particular callee. The broker application may also obtain information regarding the caller's remaining minutes or data under the caller's respective plans. The broker application may determine, for example, that placing a call through the carrier network would be most cost efficient even though its rates happen to be higher than the cost of a call through a VoIP service because the caller (with no free Wi-Fi access) does not have much remaining data quota for the current month, and the call happens to be to a particular callee and is likely to last longer than the minutes available at no extra charge over VoIP.

If more than one of the above exemplary options are available, the broker application decides which option would be most cost efficient not only in terms of extra charge but also in terms of accruing minutes or data against available quota. For example, the broker application chooses the VoIP option over the carrier network or pre-paid options if the per-minute rate of the VoIP option is the lowest cost taking into consideration both data and minute usage rates. The broker application will choose the pre-paid option over the carrier network or VoIP options if the pre-paid rate for the country of destination happens to be lower cost. The broker application, on the other hand, will place a call through the regular carrier if it determines that using an OTT VoIP service would cost more. If, for example, the call is to a domestic number, and either same-carrier free minutes or regular minutes under the caller's voice plan are available, the broker will place the call through the regular carrier. Also, if, for example, the caller does not have a Wi-Fi access and the plan data quota is exhausted and the excess data charge is greater than the cost of making a call through the regular carrier, the broker will place the call through the regular carrier.

In another scenario, a caller may subscribe to multiple plans with multiple network carriers. The caller can use a communication device capable of connecting to different networks through multiple authentication mechanisms configured on the device. The authentication mechanisms can be implemented in hardware, such as a SIM card, or in software security modules. Here, the broker application provides the caller further calling options from the various networks available either to the broker or caller, and the broker application performs selecting the most cost efficient option among them based on their respective rates, for example.

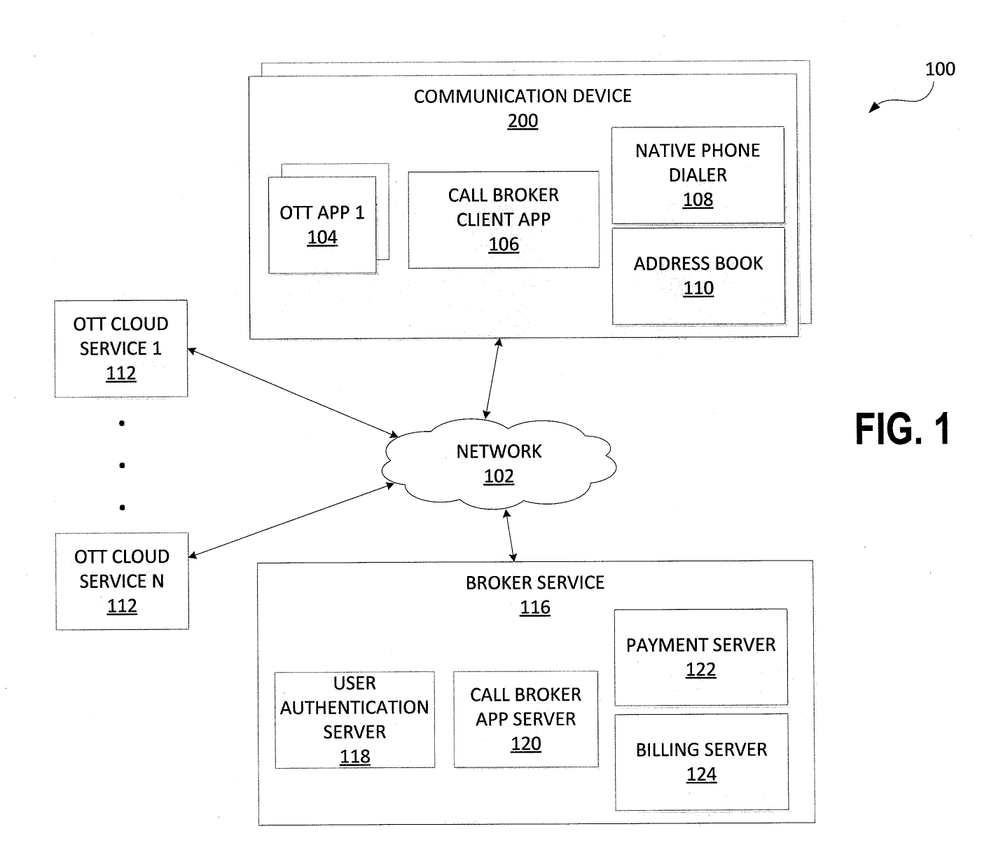

FIG. 1 is a functional block diagram of an exemplary communications system using a network, e.g., PSTN overlaid with packet switched network and having wireless access capability. The system 100 includes a portable wireless communication device 200 in communication with one or more OTT communication service providers 112 and one or more servers for call broker service provider 116 through a network 102. The communication device 200 is an electronic communication device such as a mobile phone, a smart phone, a tablet computer or other communication device configured to wirelessly transmit/receive voice and data signals.

The communication device 200 includes one or more OTT applications 104. An OTT application generally refers to an application installed on the communication device 200 that can place a call over the underlying telecommunication carrier network. The OTT applications 104 can be installed on the communication device 200 by the manufacturer, a network operator providing service for the device and/or a user of the communication device 200. The OTT applications 104 may be OTT service provider-specific or generic to enable OTT communication services through application programming interface (API) provided by the OTT communication service providers. The installation can be performed at the time of manufacture, via over the air provisioning, via storage coupled to the communication device 200 such as a SIM card, or other suitable installation means.

The communication device 200 includes a call broker client application 106. The call broker client application 106 refers to an application that executes at least part of the call broker functionalities disclosed herein. The call broker client application 106 can be an application dedicated to perform call brokerage disclosed herein or a generic application that can enable the user of the communication device 200 to utilize the call brokerage functionalities. For example, the call broker client application 106 can be a generic Internet browser application that can access data and servers necessary to perform call brokerage. The call broker client application 106 is generally configured to access various remote data and servers through the network 102 and interact with other applications on the communication device 200 through, among others, calling APIs, carrier billing APIs, carrier properties APIs and user account APIs. Exemplary calling APIs are provided by, for example, Twilio, Tropo and Skype, and they can take in parameters such as a call number to facilitate placing a call. Exemplary carrier properties APIs are provided by, for example Verizon, and they can take in parameters such as the caller's phone number to provide carrier information. Exemplary payment APIs are provided by, for example, AT&T, and they can take in parameters such as charge information to allow the call broker client application to directly bill to the caller's carrier account. The call broker client application 106 may be configured to place a call using the broker service provider's account—instead of the user's account—with the OTT communication service providers 112 as described further below.

The communication device 200 also includes a native phone dialer 108 and an address book 110. The native phone dialer 108 directly receives the user input of a destination call number. This call number is then communicated to the call broker client application 106 for selecting the optimal call option and placing a call to the destination call number. The native phone dialer 108 also has access to the address book 110 for the user to look up and dial a call number.

The communication device 200 may be configured to access the network 102 via an access point, such as a Wi-Fi access point, a cellular access point, an LTE or other 3G access point, a radio access point, a wired access point (e.g., Ethernet), or other network portal. Accordingly, the network 130 can be the PSTN, a packet switched network, a wide-area network, a private area network, a mesh network, a cellular network, a radio network, a local area network, or other such communication network configured to transmit and receive data between devices.

FIG. 1 shows a broker service provider 116 in communication with the network 102. The broker service provider 116 includes a user authentication server 118, a call broker application server 120, a payment server 122 and a billing server 124. Naturally, the server partitioning of the broker service provider 116 in FIG. 1 is but one implementation of the broker service provider 116. One of the servers of the broker service provider 116 may be implemented in a plurality of servers, and a plurality of the servers of the broker service provider 116 in FIG. 1 can be combined into one server. One or more functionalities performed by the one or more servers may also be implemented in one or more software modules. Furthermore, the broker service provider 116 may include servers or modules for providing additional services. For example, the broker service provider 116 may have one or more accounts set up with the OTT service providers 112 to provide availability of various OTT services and lower rates with the OTT services. The servers and/or modules of the broker service provider can be in communication with the call broker client application 106 to allow the call broker client application 106 to place a call through the broker service provider's own account with the OTT service providers 112 especially if the user does not have an account with such service providers or the broker service provider is in partnership with those service providers and gets better rates than the user does.

The user authentication server 118 is configured to receive authorization requests and generate an appropriate response. The user authentication server 118 can be configured to parse the authorization request to identify the information upon which the authorization determination will be made. The user authentication server 118 compares the information included in the authorization request with information included in memory. For example, if the authorization request includes a user identifier, the user authentication server 118 looks up information associated with the user identifier, and this information may then be included in the authorization response. The user authentication server 118 can be further configured to generate an authentication token to indicate the authorization determination. The authorization token can be generated only when the request is authorized. In some implementations, the token can be generated for all requests (e.g., authorized or unauthorized).

The call broker application server 120 is configured to provide and/or process necessary information for performing call brokerage disclosed herein. The call broker application server 120 receives rate information from the OTT service providers 112 and updates the call broker client application 106 with up-to-date calling rates of the OTT services. In one implementation, the broker application server 120 can store in memory the rate information obtained from the OTT service providers. The stored rate information can be updated periodically or dynamically in real-time. In another implementation, the broker application server 120 can be in further communication with the OTT service providers 112 to facilitate dynamic update of and/or request for real-time rate information. The call broker application server 120 is also configured to store and utilize information regarding the broker service provider's own account with the OTT service providers 112, in case the broker application 106 determines that using the broker service provider's own account is most optimal for the user. The call broker application server 120 can be further configured to perform some or all of the methods disclosed herein regarding selecting the most optimal call option for the user depending on the methods performed by the call broker client application 106 on the user's mobile device 200.

The payment server 122 handles payments regarding OTT services, and the billing server 124 generates a billing request to an account associated with the communication device 200. Cost of calls placed by the call broker client application 106 can be directly charged to the call broker service provider, and the call broker service provider can generate a billing request to the user account with the network carrier. Instead of getting multiple bills for using different communications services, the user may see one or more billing items on the user's regular bill with the network carrier. In producing payments and generating billing requests, the payment server 122 and the billing server 124 can be in data communication with OTT service provider servers and network carrier servers (not shown). The payment server 122 and the billing server 124 can also make use of APIs provided by the OTT service providers and network carriers.

The OTT service providers 112 are in data communication with the network 102 in FIG. 1. The OTT service providers 112 will have their own servers to store data and provide OTT service to their users. The OTT service providers 112 can also provide user- and/or device-specific account information for their services to the broker service provider 116. Thus, the user's account information with a specific OTT service can be used by the call broker application server 120 and/or the call broker client application 106 to determine the call option that optimizes factors provided by or for the user.

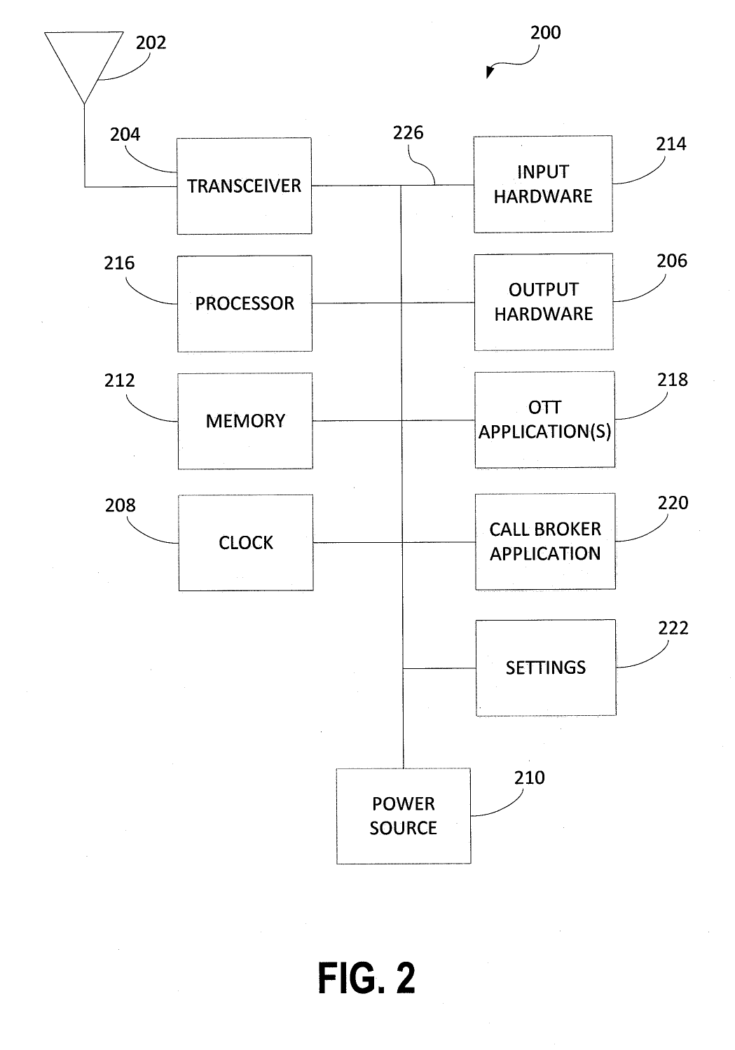

FIG. 2 is a functional block diagram of an exemplary portable wireless communications device. When implemented as a device hosting an OTT application and/or a call broker application, the communication device 200 includes hardware and software for performing the main functions of a device that has wireless communication and computing capabilities.

The communication device 200 can include one or more antennas 202 and a transceiver unit 204 for the transmission and reception of wireless signals; output hardware 206 such as an audio unit, a microphone, and/or a display screen; a clock 208; a power source 210 (e.g., battery, solar panel, wired power connection); a memory 212, input hardware 214 such as a keypad or touchscreen for receiving a user input, a GPS unit for indicating the geographical location of the device, a wired network connection (e.g., Ethernet port); a processor 216; and one or more communication buses 226. Some output hardware 206 such as a display screen can include a touch sensitive screen. Accordingly, some output hardware 206 provides input functionality and some input hardware 214 provides output functionality. The memory 212 can include one or more memory circuits including non-volatile memory circuits (e.g., EEPROM, FLASH, etc.).

Depending on the capabilities of the communication device 200 and the supporting telecommunication networks the communication device 200 can also provide a range of voice and data communication services. As non-limiting examples, the communication device 200 provides telephone network based communication services including voice, multimedia and text messaging, as well as other data exchange capabilities, enabling Internet access and email exchange

The communication device 200 can be configured to exchange data via a 3G network with remote servers such as an operator server and/or an application provider, and to enable data exchange enabling Internet access (e.g., data network). The communication device 200 is operable to have software applications installed, such as, but not limited to social networking applications or email applications, for example, which when executed may exchange data with the remote servers. Each application installed on the communication device 200 can have an associated graphical user interface.

The communication device 200 can also include one or more OTT applications 218 and a call broker application 220. The communication device can further include global or application-specific settings 222. In selecting the most optimal call option, the call broker application 220 may use the settings 222. In placing calls the call broker application 220 may use the OTT application 218 installed on the communication device 200.

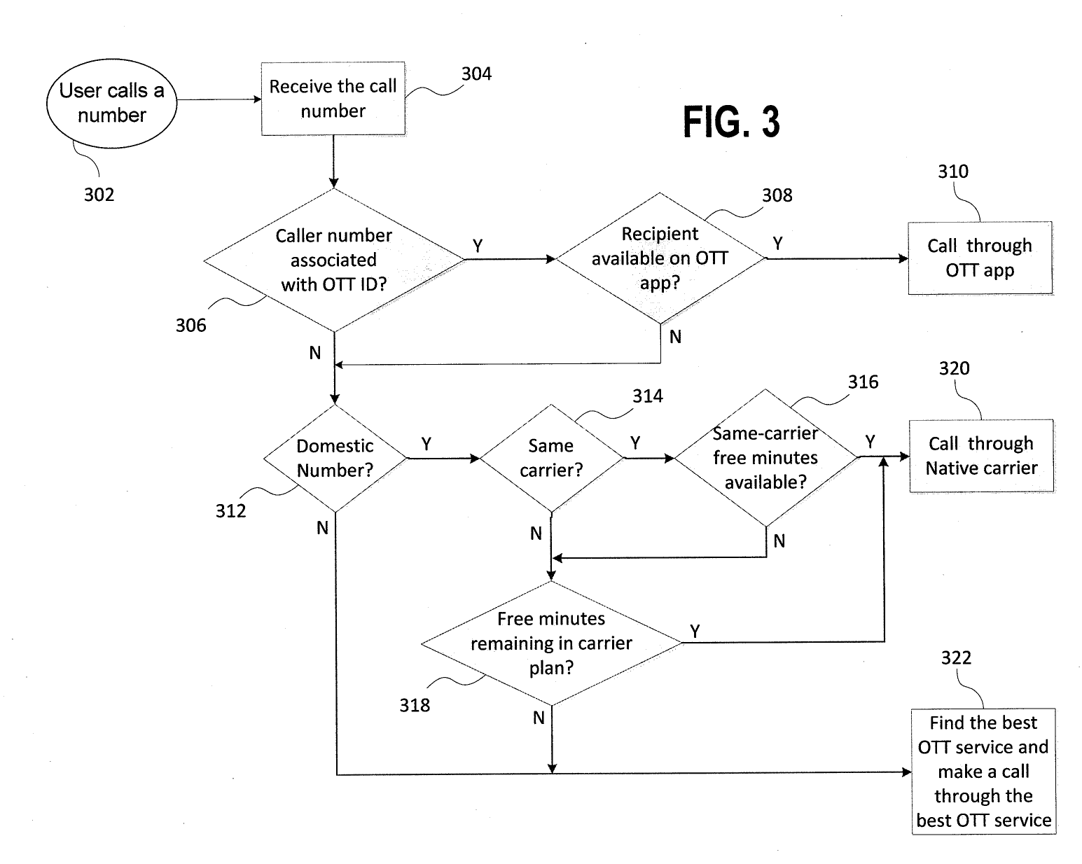

FIG. 3 is a flowchart for an exemplary method of call routing. The method shown in FIG. 3 is implemented via a communication device such as the communication device 200 shown in FIG. 2. The method shown in FIG. 3 is also generally implemented with a call broker application server 120 in conjunction with other servers of the broker service provider 116.

At initiation block 302, a call number is dialed by the user on the user device. In one implementation, the user makes a call through a native dialer as if making a regular call over the carrier network. In another implementation, the user makes the call on a non-native calling application, an OTT application or a broker application. Once the user dials the destination number on the user device, call routing is initiated, and the process starts from block 304.

At block 304, the call number the user dialed at block 302 is received. Instead of letting the call go through the regular carrier, the broker application receives the call number to begin the process of determining what is considered to be the optimal call option for the particular caller. Once the destination call number is received, the process continues to decision block 306.

At decision block 306, a determination is made as to whether the caller's number is associated with an OTT ID. If the caller's number is associated with an OTT service user ID, the user's account with the OTT service may be used to place a call and the process continues to decision block 308. If the caller's number is not associated with an OTT service user ID, the process continues to decision block 312.

At decision block 308, a determination is made as to whether the recipient is available on the OTT service application. If the recipient is available on the OTT service application, the process continues to block 310. If the recipient is not available on the OTT service application, the process continues to decision block 312.

At block 310, the call is placed through the OTT application. At this point the determination has been made that placing the call through the OTT application is the most cost efficient option, and the call will be placed through the OTT application to the recipient of the call.

At decision block 312, a determination is made as to whether the dialed number is a domestic number. If the dialed number is a domestic number, the process continues to decision block 314. If the dialed number is not a domestic number (i.e., an international number), the process continues to block 322.

At decision block 314, a determination is made as to whether the caller and the recipient are on the same carrier network. If the caller and the recipient are on the same carrier network, the process continues to decision block 316. If the caller and the recipient are not on the same carrier network, then the process continues to decision block 318.

At decision block 316, a determination is made as to whether any same-carrier plan minutes are available. If any same-carrier minutes are available for the user based on various conditions preset by the user's voice plan, the process continues to block 320. If no same-carrier free minutes are available due to, for example, lack of such offer in the user's voice plan or failure to meet the condition (e.g., time of the day) by the user, the process continues to decision block 318.

At decision block 318, a determination is made as to whether any free minutes are remaining in the user's carrier plan. Using such remaining minutes will not incur any extra charge for making the call as long as the user stays within the quota, but the user may accrue minutes against the quota. If there are minutes remaining in the user's carrier plan, the process continues to block 320. If there are no minutes remaining in the user's carrier plan, the process continues to block 322.

At block 320, the call is placed through the network carrier. At this point the determination has been made that calling through the user's native carrier network is the most optimal option for the user, and the call will be place through the carrier network.

At block 322, the call is placed through the best available OTT service. At this point the determination has been made that placing the call through an OTT service is the somehow best option for the user. Further determination will be made within this block to compare rates of different OTT services, and the determination will further depend on, among others, the destination of the call and any available partnership discount. Once the most cost effective OTT service option is determined, the call will be placed through that selected OTT service.

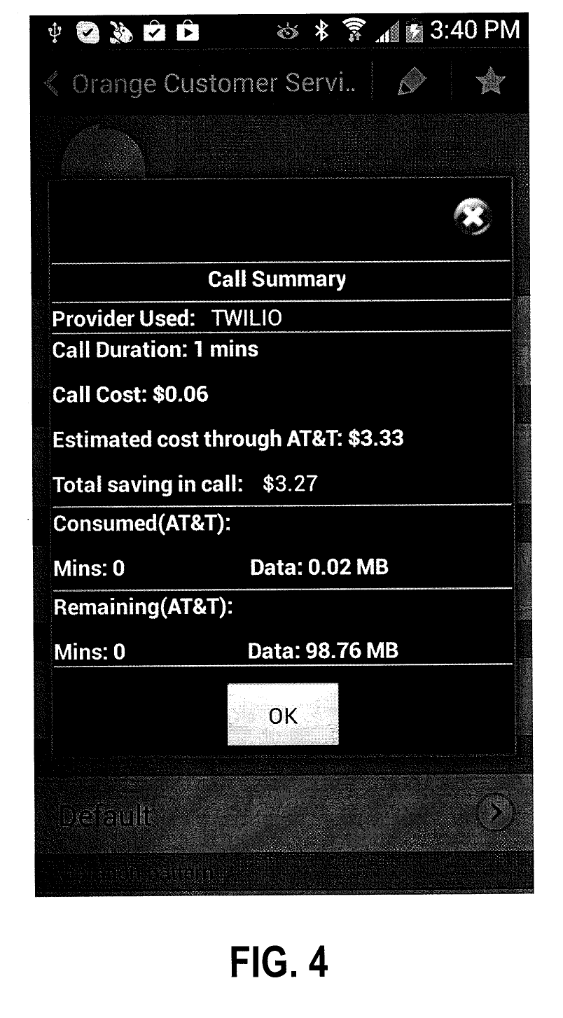

FIG. 4 is an illustration of an exemplary call summary screen shot of a call broker application once a call has been completed. FIG. 4 illustrates the type of information the call broker application processes in order to place a call through the selected communication service provider. As shown in FIG. 4, the broker application, in this exemplary case, selected an OTT service provider (“Twilio”) instead of the native network carrier (“AT&T”) based at least partly on the zero remaining minutes on the network carrier plan. Based on the duration of the call, the broker application has calculated and displays the calculated estimated cost savings. The screen shot also shows the data and minutes consumed in this call and remaining after the call.

One non-limiting advantage of the described aspects is selection of a cost efficient call option without the user having to compare various call rates and pricing schemes or switching to various applications. The user will only have to dial a call number as the user would dial any regular number through the native network carrier. Therefore, the user does not have to open different applications and sign in to use different OTT applications, for example. Furthermore, the user need not compare various rates or look up minutes or data remaining under the user's subscribed plans to determine which option would be the most cost efficient one. Since the call broker application can be updated for any changes in rates automatically, the selection of the most cost efficient call option may always be based on up-to-date rates information, and the user may not be required to check whether the rates for a particular OTT service, for example, have changed before the user make a call.

Another non-limiting advantage of the described aspects is that the user may take advantage of the broker service provider's own account and any potential partnership discounts. Even if the user knows of all the various OTT communication services, for example, it would be difficult to manage multiple accounts for all the available OTT communication services. Without setting up and managing multiple accounts for different OTT services, the user may not fully take advantage of all the available cost efficient call options. Instead, through a call broker application, the user can benefit from the accounts already set up by the call broker without having to set up and manage the user's own account. Furthermore, the call broker service provider may enter into partnership with one or more of the available communications service providers and may get lower rates for placing calls through those communication service providers than the user would get. In such cases, the user may be able to benefit from the partnership discounts between the broker service provider and the communication service providers.

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different data access technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The various operations of methods described above may be performed by any suitable means capable of performing the operations, such as various hardware and/or software component(s), circuits, and/or module(s). Generally, any operations illustrated in the figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a device as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a device can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

1. A method comprising:
routing a call from a caller's communication device to a recipient with a broker application hosted on the communication device, the method comprising the following acts performed by the communication device:
receiving a destination number for the call;
identifying a plurality of communication services available to the communication device to call the destination number;
obtaining cost factor information for the plurality of available communication services using an application interface of at least one communication service provider;
determining cost of calling the destination number through each of the plurality of communication services based on the cost factor information;
selecting a communication service from the plurality of communication services based at least in part on the determined cost; and
placing the call to the destination number through the selected communication service.

2. The method of claim 1, further comprising:
charging the broker application provider for the call to the destination; and
billing the communication device through the caller's carrier using a carrier application interface.

3. The method of claim 1, further comprising:
updating call rate information from an over-the-top communication service provider.

4. The method of claim 1, wherein the plurality of available communication services includes at least one voice-over-IP service.

5. The method of claim 1, wherein selecting the optimal communication service is based in part on quality of service (QoS) of the communication service.

6. The method of claim 1, wherein selecting the optimal communication service is based in part on existence of an installed application for the communication service.

7. The method of claim 1, wherein placing the call to the destination number is performed using the broker application provider's account with the selected communication service.

8. The method of claim 1, wherein the cost factor information includes at least one of:
time of day;
country of destination;
call rate set by an over-the-top communication service provider;
over-the-top communication service account of the caller;
carrier of the caller;
carrier of the recipient;
call history of the caller;
availability of the recipient through at least one of the communication services;
existence of the caller's communication service account;
predetermined rate of at least one of the plurality of communication services;
carrier plan of the caller; and
network connectivity.

9. A communication device for routing a call from a caller to a recipient with a broker application hosted on the communication device, the communication device comprising:
a processor configured by software to:
receive a destination number for the call;
identify a plurality of communication services available to the communication device to call the destination number;
obtain cost factor information for the plurality of available communication services using an application interface of at least one communication service provider;
determine cost of calling the destination number through each of the plurality of communication services based on the cost factor information;
select a communication service from the plurality of communication services based at least in part on the determined cost; and
place the call to the destination number through the selected communication service.

10. The communication device of claim 9, wherein the system is further configured to:
charge the broker application provider for the call to the destination; and
bill the communication device through the caller's carrier using a carrier application interface.

11. The communication device of claim 9, wherein the system is further configured to:
update call rate information from an over-the-top communication service provider.

12. The communication device of claim 9, wherein the plurality of available communication services includes at least one voice-over-IP service.

13. The communication device of claim 9, wherein selecting the optimal communication service is based in part on quality of service (QoS) of the communication service.

14. The communication device of claim 9, wherein selecting the optimal communication service is based in part on existence of an installed application for the communication service.

15. The communication device of claim 9, wherein placing the call to the destination number is performed using the broker application provider's account with the selected communication service.

16. The communication device of claim 9, wherein the cost factor information includes at least one of:
time of day;
country of destination;
call rate set by an over-the-top communication service provider;
over-the-top communication service account of the caller;
carrier of the caller;
carrier of the recipient;
call history of the caller;
availability of the recipient through at least one of the communication services;
existence of the caller's communication service account;
predetermined rate of at least one of the plurality of communication services;
carrier plan of the caller; and
network connectivity.

17. An application embodied on a non-transitory computer readable medium, the application being configured to route a call from a caller's communication device to a recipient, the application comprising instructions for:
receiving a destination number for the call;
identifying a plurality of communication services available to the communication device to call the destination number;
obtaining cost factor information for the plurality of available communication services using an application interface of at least one communication service provider;
determining cost of calling the destination number through each of the plurality of communication services based on the cost factor information;
selecting a communication service from the plurality of communication services based at least in part on the determined cost; and
placing the call to the destination number through the selected communication service.

18. The application of claim 17, further comprising instructions for:
charging the broker application provider for the call to the destination; and
billing the caller through the caller's carrier using a carrier application interface.

19. The application of claim 17, further comprising instructions for:
updating call rate information from an over-the-top communication service provider.

20. The application of claim 17, wherein the plurality of available communication services includes at least one voice-over-IP service.

21. The application of claim 17, wherein selecting the optimal communication service is based in part on quality of service (QoS) of the communication service.

22. The application of claim 17, wherein selecting the optimal communication service is based in part on existence of an installed application for the communication service.

23. The application of claim 17, wherein placing the call to the destination number is performed using the broker application provider's account with the selected communication service.

24. The application of claim 17, wherein the cost factor information includes at least one of:
time of day;
country of destination;
call rate set by an over-the-top communication service provider;
over-the-top communication service account of the caller;
carrier of the caller;
carrier of the recipient;
call history of the caller;
availability of the recipient through at least one of the communication services;
existence of the caller's communication service account;
predetermined rate of at least one of the plurality of communication services;
carrier plan of the caller; and
network connectivity.
